(19) United States
(12) Patent Application Publication
(10) Pub. No.: US 2021/0012337 A1
(43) Pub. Date: Jan. 14, 2021

(54) MERCHANT-LEVEL BLOCKING MECHANISM

(71) Applicants: Basudeb Ghosh, Foster City, CA (US); Mohit Kudalkar, Palo Alto, CA (US); Arnab Dutta, Palo Alto, CA (US); Sharon Geevarghese Kuriakose, Austin, TX (US); Raveen Ollalwar, Foster City, CA (US); Mahesh Joshi, Palo Alto, CA (US); Naga Krishna Vadlamudi, Austin, TX (US); Vijaya Bhat, Foster City, CA (US); Prithwiraj Mitra, Foster City, CA (US); Vinoth Rajkumar, Foster City, CA (US)

(72) Inventors: Basudeb Ghosh, Foster City, CA (US); Mohit Kudalkar, Palo Alto, CA (US); Arnab Dutta, Palo Alto, CA (US); Sharon Geevarghese Kuriakose, Austin, TX (US); Raveen Ollalwar, Foster City, CA (US); Mahesh Joshi, Palo Alto, CA (US); Naga Krishna Vadlamudi, Austin, TX (US); Vijaya Bhat, Foster City, CA (US); Prithwiraj Mitra, Foster City, CA (US); Vinoth Rajkumar, Foster City, CA (US)

(21) Appl. No.: 16/506,378

(22) Filed: Jul. 9, 2019

(51) Int. Cl. G06Q 20/40; G06Q 20/38; G06Q 20/42

(52) U.S. Cl. CPC G06Q 20/405; G06Q 20/42; G06Q 20/388

(57) ABSTRACT

Payment instruments used on behalf of a sponsor may be restricted from use at certain locations. The sponsor may indicate that use of the payment instrument at either specific merchants or certain categories of merchants is not in accordance with the sponsor's goals or values. A system evaluates every transaction request to determine if the personal account number of the payment instrument is associated with the sponsor. If so, the transaction may be further screened to determine if the transaction is from a location to be blocked, in which case a flag may be added to the transaction indicating it is from blocked location. An issuer of the payment instrument may then determine whether to approve or deny the transaction. A tool may generate a dataset of locations and/or merchant categories for use in identifying blocked locations.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Financial transaction instruments such as payment cards used by individuals may be sponsored by another entity, such as a corporation or even a parent. The sponsor may wish to limit the use of card to transactions that are consistent with the sponsors policies and/or values.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In some embodiments, transaction authorizations received for an individual payment card are compared to a list of businesses that fall outside the guidelines established for use of that payment card. When the request is associated with such a business, a flag is set and the transaction authorization may be denied.

### BRIEF DESCRIPTION OF THE DRAWINGS

FIG. 1 illustrates a system supporting selective transaction rejection in accordance with the current disclosure;

FIG. 2 is an alternate embodiment of the system of FIG. 1;

FIG. 3 illustrates an exemplary table showing one schema for use with the system of FIG. 1 or 2;

FIG. 4 illustrates exemplary tables showing alternate schema for use with the system of FIG. 1 or 2; and

FIG. 5 is an illustration of an exemplary user interface that may be used to capture merchant locations to be selectively blocked in accordance with the current disclosure.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

A sponsor of a financial instrument, as used here, may be a corporate, government, or an individual who provides a payment instrument to a person for use on behalf of the sponsor. In some cases, a corporation may provide a credit card to an employee who acts on behalf of the of corporation. The employee may be a buyer who purchases goods and services for the corporation, may be a salesperson who entertains customers and potential customers, or may be an executive who travels frequently on behalf of the company. In another case, a parent may give a credit card to a child who is away at school for use in paying school and living expenses.

In most cases, the sponsor has a set of values and standards (either corporate or personal) that define some kind of acceptable use. In many cases, the standards involve acceptable use of the sponsor's funds and the difficulty of explaining use of the payment instrument at establishments that are at odds with the sponsor's values. When inappropriate charges do occur, it may often be difficult to untangle the financial and public relations impacts. For example, not only may a company be obligated to pay the offending charge but it must then decide what action to take against the employee.

While many obvious cases of such “off-limits” establishments may involve adult entertainment, gambling, or legalized drugs, others may also apply. A company that sells vegan products may not want their card used at a steak house. A parent whose child lives on a walking campus may not want the student paying for gas. High-end audio or computer gaming equipment may not fall within the bounds of expected employee purchases.

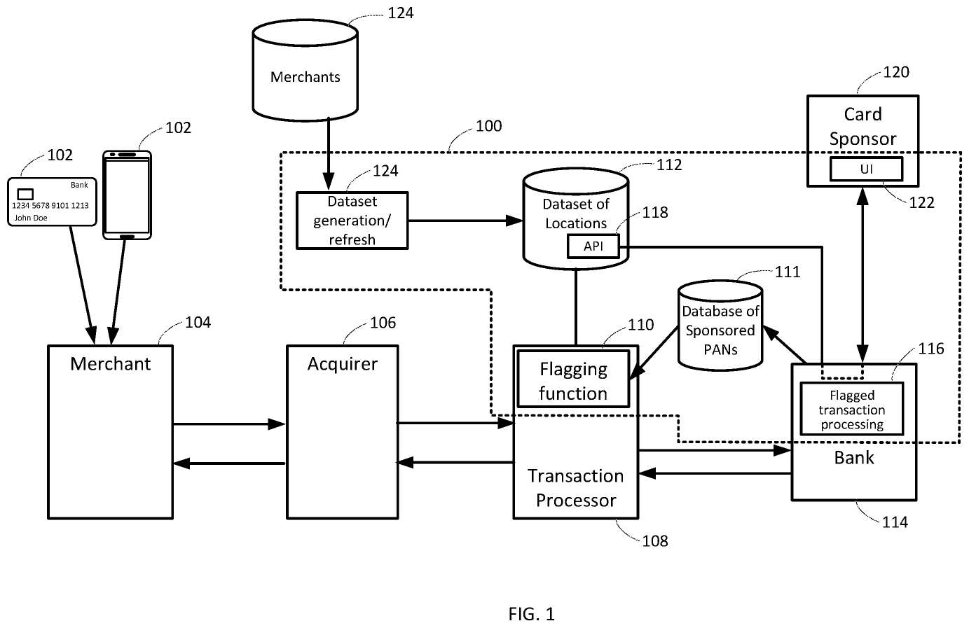

FIG. 1 illustrates a system 100 that is part of a larger transaction processing environment. The transaction processing environment may follow traditional processing flows with the exception of the additional databases and functions as described below.

In an embodiment, a merchant 104 may initiate a financial transaction by accepting a payment instrument 102 to complete a purchase. The payment instrument 102 may be any of several methods of conveying payment details including, but not limited to, a physical card, a tokenized value presented via a cell phone, or a barcode (not depicted). The merchant 104 may forward a payment bundle including its own merchant identifiers, the payment amounts, payment instrument details, and transaction type, among others. An acquirer 106 (also called merchant acquirer or payment gateway) may accept the transaction details and route a request for approval of the transaction to a processor 108. In an embodiment, the processor 108 may be a network such as Visa®. If the payment instrument 104 is in tokenized form, the token may be processed to recover a personal account number (PAN). Otherwise, a PAN may be extracted from the transaction request.

At this point, a flagging function 110 may examine the transaction request, and more particularly, the PAN. The flagging function 110 may determine if the PAN of the transaction request belongs to a set of PANs for which restrictions have been placed. For example, a database of such PANs 111 may be consulted using the PAN as an index. If the PAN has no restrictions and/or is not present in the database 111, the transaction may be processed conventionally.

If, however, the PAN is present in the database 111 and has restrictions, the flagging function 110 may further compare merchant/location information from the transaction to a dataset (or database) of locations 112. The dataset of locations 112 may indicate whether the merchant 104 is to be blocked from transactions for the current PAN. There are numerous ways in which the comparison may be made, as will be discussed more below. However, in general, a merchant/location reference associated with the PAN may indicate which locations to search for in the dataset of locations 112. A match between the merchant 104 and an entry in the dataset of locations 112 may indicate that a sponsor of the payment instruments 102 has requested that transactions with that merchant 104 are to be rejected. In nominal transaction processing flows, the transaction processor 108 does not approve or reject transactions, with that responsibility falling on the bank 114 or issuer of the payment instrument 102. In order to retain the nominal flow of processing, the transaction request may simply be supplemented with a flag. A flagged transaction processing function 116 at the bank 114 may read the flag indicating that the transaction merchant/location is not authorized for that PAN. The bank 114 may then simply reject the transaction request using either a new or an existing failure code. That is, the acquirer 106 and ultimately the merchant 104 will be notified that the payment instrument has been denied and a holder of the payment instrument will either need to reconsider the transaction or use a another, likely personal, payment instrument.

There are also several conditions which may affect the ability to uniquely identify a merchant or location. For example, some merchants may share identifying information or share an address. In other cases, a payment processor may act as a clearinghouse for transactions so the actual provider of goods or services may be not be obvious from the details of the transaction request. The response to an inability to fully identify a merchant/location may be handled in several ways, according to a preference of the transaction processor 108, an issuer 114, or the sponsor of the payment instrument 102. In one case, an inability to completely identify the merchant 104 may result in no flag being set and the transaction being allowed to continue for normal processing. In another case, such an inability to identify the merchant 104 with specificity may result in the flag being set and the transaction being denied.

In order to provide the data necessary for flagging transactions, three sets of data may be generated. The first may be a list of payment instruments for which blocking is to be applied. A second may be a list of merchants or categories that a payment instrument sponsor wishes the block. The third may be a dataset of merchants and/or their locations that meet the criteria for blocking specified by the sponsor.

In order to populate the first list, illustrated in FIG. 1 as the database 111, the bank 114 (or other card issuer) may generate a list of payment instruments associated with the card sponsor 120. In one embodiment, the bank 114 may generate the list responsive to card sponsor 120 selections made via a user interface 122 coupled to the bank 114. In another embodiment, the bank 114 may simply act on an instruction from the card sponsor 120 and generate the necessary tables for the database 111 for all sponsored cards. As may be apparent, the actual owner of the database 111, such as the transaction processor 108, may be involved in one or more security aspects related populating and maintaining the database 111, such as authentication and authorization verifications.

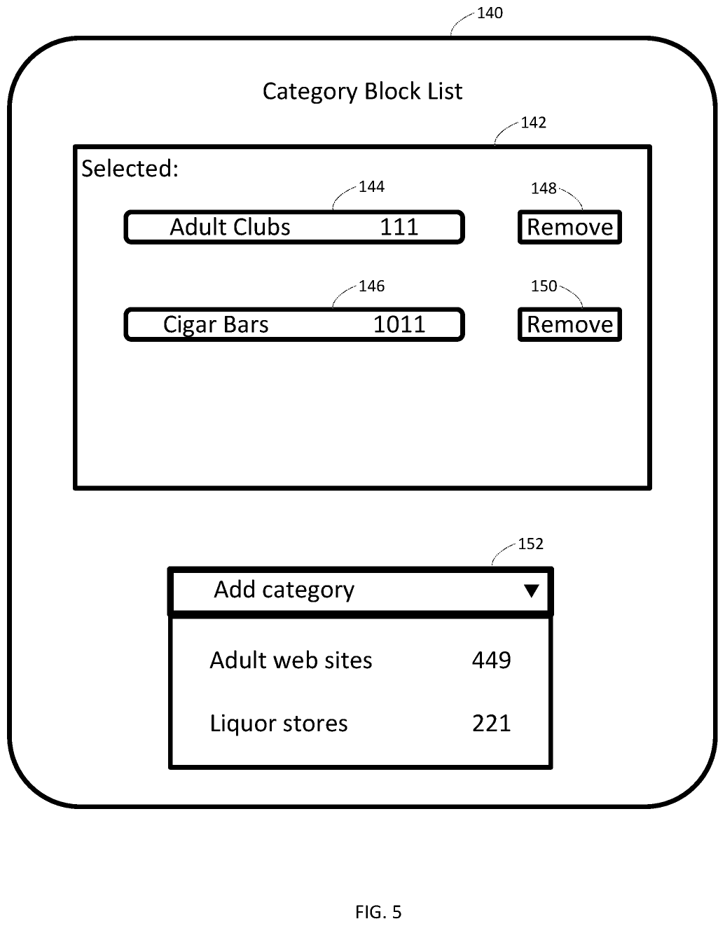

The second dataset, the list of merchants to be blocked, may be populated in one embodiment by the card sponsor 120, also via the user interface (UI) 122. In some cases, the UI 122 may simply be a browser that connects to a host via an application program interface (API) 118. Turning briefly to FIG. 5, an exemplary user interface 140 for selecting locations to be blocked may be illustrated. A first window 142 may show already selected locations 144, 146, which in this illustration are shown by category. Buttons 148, 150 may allow a selected category to be removed. An “Add Category” drop down 152 may provide for selection of additional categories. Other implementations of location selection may be supported. For example, a card sponsor may be able to select individual location names which may be added implicitly. In another case, individual merchant names may be used to generalize a category to which that merchant belongs. For example, “Fred's Brandy and Cigars,” especially when aided by other data such as MCC, may be used to generalize a category of cigar bars.

The third set of data required for flagging transactions may be a list of merchant locations 124. Such a database 124 may exist as part of a registration function of the transaction processor 108 simply as a means of establishing a business relationship to support processing payment cards. Such a list 124 may be independently developed and maintained and may include assigned or self-defined references to business types such as a merchant category code (MCC).

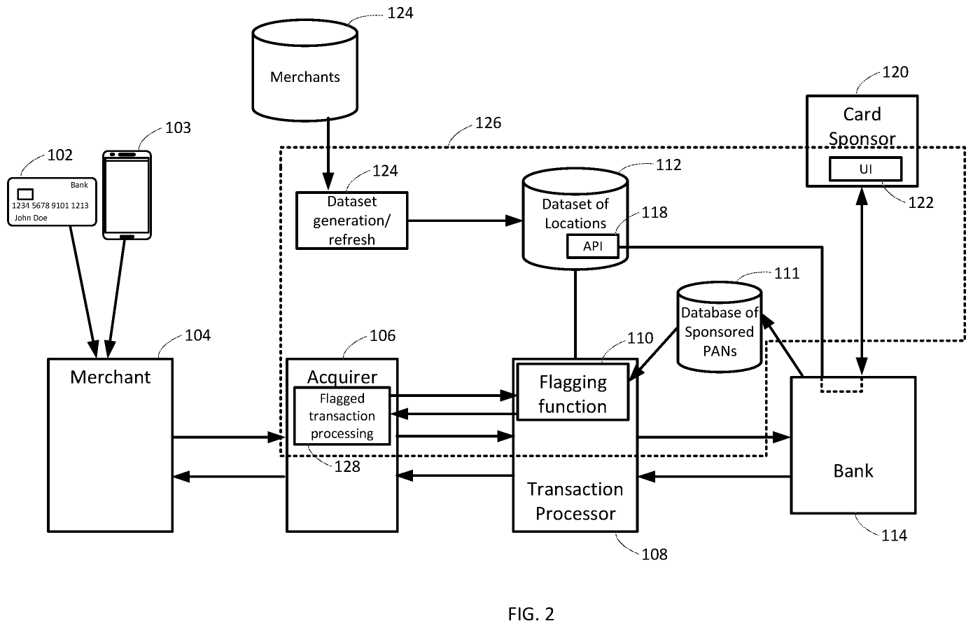

FIG. 2 may illustrate an alternate embodiment of a system 126, where, instead of flagging a transaction in order to defer a decision to the bank 114, the transaction request may be flagged and returned to the acquirer 106. The acquirer 106 may invoke a flagged transaction processing function 128 to determine that the transaction should be rejected. In this embodiment, the extra steps associated with sending the transaction request to the bank for processing are removed, reducing overhead and time on a transaction that will ultimately be denied. The acquirer 106 may simply act on rules already in place to deny transactions where a risk level exceeds an acceptable limit.

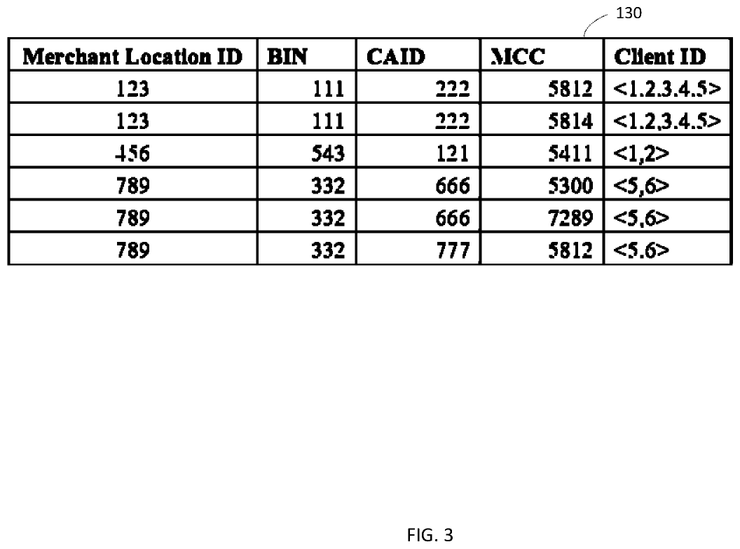

Further to making the comparison of data from the transaction request to merchants/locations to be blocked, FIG. 3 may illustrate a table 130 suitable for use in one such embodiment. The table 130 may show a merchant location identifier, a bank identification number (BIN) and a cardholder acceptance identifier (CAID). The MCC, discussed above, may give a general indication of the type of goods or services provided by the merchant, such as fast food or clothing. Even though some rows may have identical Merchant ID, BIN, and CAID, the MCC may be different, indicating perhaps that more than one good or service is available from that location. The combination of four initial columns of identifiers may help to uniquely identify a location. In some embodiments, more or fewer columns may be used. For example, a physical address or a business name may be used to further narrow a match.

The client ID column may indicate a card sponsor for which transactions are to be blocked. That is, a merchant in a row where the client ID appears are to be denied. While the contents of the illustrated table are simplified, the actual contents of a such a table may be complex. For example, many more client identifiers may be included in the Client ID column. However, in some cases, a unique table 130 may be generated for each client/card sponsor wishing to block transactions. In that case, no Client ID column would be needed since the table itself would be dedicated to an individual card sponsor.

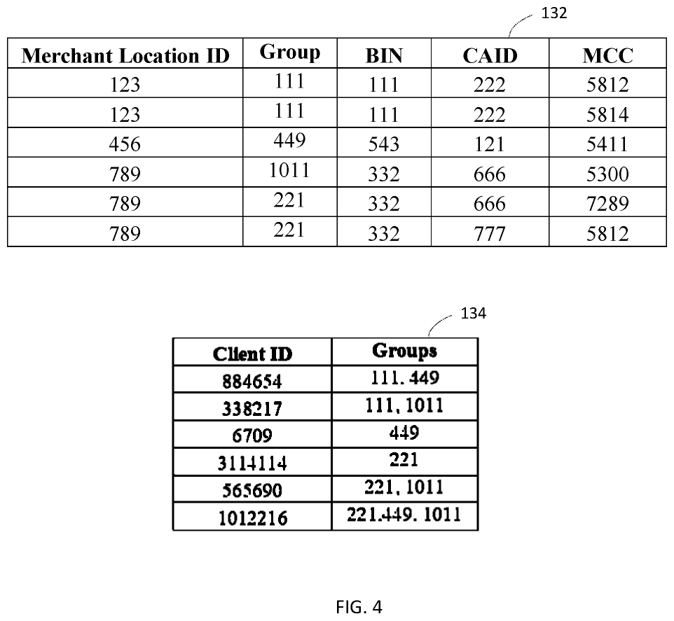

FIG. 4 illustrates another possible implementation for matching card sponsors to merchants to be blocked. Table 132 illustrates similar data to that of FIG. 3, without the Client ID column and with a Group column added. Each row represents a merchant/location and a Group identifier assigned to that row of data based on general business type, such as adult entertainment, gambling establishment, arcade, etc. A second table 134 may simply associate card sponsor identifiers (Client ID) with one or more groups of merchant types to be blocked. In an embodiment, this Group ID may correspond to the contents of the drop down box 152 of FIG. 5. In this way, a card sponsor 120 can easily identify groups of merchants for which its card holders are to be blocked.

A technical effect of the described system and method is the use of an application program interface (API) 118 and user interface 122 for presenting selectable choices to a card sponsor 120 for selective transaction blocking. The UI 122 may be hosted by an issuing bank 114 associated with the card sponsor 120 or a transaction processor 108 hosting a dataset of locations 112. The user interface 122 implements a technological solution to a longstanding problem of abuse of financial instruments dedicated to a particular purpose.

These techniques benefit card sponsors, card issuers, and ultimately card users. By blocking transactions before they occur, disputed transactions are avoided, along with human relations (HR) actions for employees involved in such transactions and possible chargebacks involving issuing banks 114, acquirers 106 and the merchants 104 themselves.

The figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of selectively rejecting transactions in a processing system, the method comprising:
identifying a personal account number (PAN) associated with one or more payment instruments;
identifying a merchant characteristic for which transaction requests using the PAN are to be denied;
identifying merchant locations associated with the merchant characteristic;
generating a dataset of unique locations associated with transactions to be denied;
receiving a transaction request from a merchant, the transaction request associated with the PAN;
identifying a location of the merchant using information in the transaction request;
comparing the location of the merchant of the transaction request with the dataset of unique locations;
responsive to a match between the location of the merchant and a location from the dataset of unique locations, adding a flag to the transaction request indicating the match; and
providing the transaction request including the flag to an issuer associated with the PAN for use in determining the rejection of the authorization request.

2. The method of claim 1, wherein the dataset of unique locations includes records comprising a bank identifier (BIN), store location identifier (CAID), and a merchant category code (MCC).

3. The method of claim 2, wherein the dataset of unique locations excludes locations where multiple locations share a common BIN/CAID/MCC designator.

4. The method of claim 1, wherein generating the dataset of unique locations comprises:
periodically scanning a compilation of all active merchants to identify those having the merchant characteristic; and
generating an updated dataset of unique locations.

5. The method of claim 1, wherein the dataset of unique locations includes categories of business types with which merchant locations are associated.

6. The method of claim 5, wherein generating the dataset of unique locations comprises generating a dataset of categories of business types for which transaction requests using the PAN are to be denied.

7. The method of claim 1, wherein identifying the PAN comprises receiving a plurality of personal account numbers from a sponsor of the payment instrument.

8. The method of claim 1, further comprising receiving, from the issuer, a transaction denial message corresponding to the transaction request.

9. The method of claim 1, wherein comparing the location of the merchant of the transaction request with the dataset of unique locations comprises matching the BIN/CAID/MCC of the transaction request with a corresponding BIN/CAID/MCC in the dataset of unique locations.

10. The method of claim 1, wherein identifying the merchant characteristic for which transactions using the PAN are to be denied comprises identifying merchants by one of a merchant identifier or a store identifier.

11. A processing system that selectively rejects transactions, comprising:
a dataset of unique locations;
a transaction processing system coupled to the dataset of unique locations, the transaction processing system including a flagging function that:
receives a transaction request;
identifies a transaction request by a financial instrument having a personal account number (PAN);
extracts information from the transaction request to determine a location of the transaction;
compares the location of the transaction to the dataset of unique locations;
responsive to a match between the location of the transaction and a member of the dataset of unique locations the transaction processing system, sets a flag in the transaction request to generate an updated transaction request for use by an authorizing agency; and
forwards the updated transaction request to an authorizing agency.

12. The processing system of claim 11, further comprising a dataset generation tool including a database query function and a filter used to generate the dataset of unique locations.

13. The processing system of claim 12, wherein the dataset generation tool database query function collects data from a merchants database, the merchants database representing a list of known locations available for transactions.

14. The processing system of claim 11, wherein a sponsor of the payment instrument has set the contents of the dataset of unique locations.

15. The transaction processing system of claim 14, further comprising a user interface that supports setting the contents of the dataset of unique locations.

16. The processing system of claim 11, wherein the sponsor of the payment instrument has selected categories used to populate the dataset of unique locations.

17. The processing system of claim 16, further comprising a user interface that supports selection, by the sponsor of the payment instrument, of the categories used to populate the dataset of unique locations.

18. The processing system of claim 11, further comprising a transaction processing function at the authorizing agency, the transaction processing function identifying the flag in the updated transaction request and rejecting the transaction based on the presence of the flag.

19. A method of selectively rejecting transactions in a processing system, the method comprising:
receiving a transaction request from a merchant, the transaction request including a personal account number (PAN), the PAN associated with one or more payment instruments;
identifying a location of the merchant using information in the transaction request;
comparing the location of the merchant of the transaction request with a dataset of unique locations;
responsive to a match between the location of the merchant and a location from the dataset of unique locations, adding a flag to the transaction request indicating the match to generate an updated transaction request; and
providing the updated transaction request to an issuer associated with the PAN for use in determining the rejection of the authorization request.

20. The method of claim 19, wherein the location of the merchant is one of a physical location and an online presence.
